(19) United States
(12) Patent Application Publication
(10) Pub. No.: US 2004/0139479 A1
(43) Pub. Date: Jul. 15, 2004

(54) Content Receiving apparatus

(76) Inventors: Masaru Kato, Osaka (JP); Kazuhiro Ieda, Osaka (JP)

Correspondence Address: Gerald T. Bodner, Esq., BODNER & O'ROURKE, LLP, Suite 108, 425 Broadhollow Road, Melville, NY, 11747, US

(21) Appl. No.: 10/745,144

(22) Filed: Dec. 23, 2003

(30) Foreign Application Priority Data
Dec. 25, 2002 (JP) 2002-374178

(51) Int. Cl. H04N 7/173; H04N 11/04; H04N 11/02; H04N 7/12; H04B 1/66; H04N 7/16

(52) U.S. Cl. 725/132; 725/140; 725/152; 375/240.28

(57) ABSTRACT

A content receiving apparatus includes a television broadcast receiving circuit. The television broadcast receiving circuit turns on a power of a tuner before a start of a broadcast of a desired television program, and fetches a standard time from a broadcast signal of a television broadcast. As a result, in a case that a local time is delayed than the standard time, information on the delay is stored in a memory. Next, when the standard time is rendered a television program starting time, a switch of the tuner is turned on so as to start recording the television program. Furthermore, an after-recording reproduction is performed from a time that the local time is rendered the television program starting time. This allows a user to watch/listen to the television program while the recording is being continued. In addition, when the user has no time to watch/listen to the television program by the after-recording reproduction, the recording is continued until a television program ending time. In this case, the use can watch/listen to the recorded television program when the user has the time.

### BACKGROUND OF THE INVENTION

1. Field of the Invention

The present invention relates to a content receiving apparatus. More specifically, the present invention relates to a content receiving apparatus adapted to a handheld terminal having a digital television broadcast receiving function, provided with a clock circuit keeping a local time, and receiving a desired content signal transmitted using a standard time as a reference.

2. Description of the Prior Art

In the prior art, in a case of watching/listening to a television broadcast by a handheld terminal having a digital television broadcast receiving function, if a start time of a desired television program is registered in advance, irrespective of a time (local time) shown by a contained clock, the handheld terminal detects a television program starting time registered based on a time (standard time) included in a broadcast signal, and starts receiving the television broadcast.

However, a user can adjust the clock of the handheld terminal to an arbitrary time, and therefore, this may lead to a case that the local time is deliberately set to a time different from the standard time, according to a user's activity pattern. Such the user often turns on the power of the tuner in the handheld terminal based on the local time in a case of watching/listening to the television program using the handheld terminal, too. In addition, even if the local time is not deliberately delayed, there is a case that the local time is faster or delayed than the standard time.

If the broadcast signal of the television broadcast is thus received based on the local time not in agreement with the standard time, in a case that the local time is delayed than the standard time, the desired television program is already started, and therefore, an early portion of the television program is missed. In contrary, in a case that the local time is faster than the standard time, the power of the tuner is tuned on before a start of the television program, and therefore, it is obliged to wait until the television program starting time with the tuner being turned on.

### SUMMARY OF THE INVENTION

Therefore, it is a primary object of the present invention to provide a novel content receiving apparatus. It is another object of the present invention to provide a content receiving apparatus capable of comfortably appreciating a desired content even when a deviation occurs between a standard time and a local time.

A content receiving apparatus according to the present invention is provided with a clock circuit keeping a local time, and receiving a desired content signal transmitted using a standard time as a reference, and comprises: a specifier for specifying a transmission starting time of the desired content signal; an issuer for issuing a message at the transmission starting time when the local time is faster than the standard time; and a recorder for starting recording the desired content signal from the transmission starting time when the local time is delayed than the standard time.

A content receiving apparatus provided with a clock circuit keeping a local time, and receiving a desired content signal transmitted using a standard time as a reference specifies a transmission starting time of a desired content signal. In addition, the content receiving apparatus issues a message to a user at the transmission starting time when the local time is faster than the standard time. Therefore, the user can watch/listen to a television program at the same time as starting a broadcast of the television program, record the television program so as to watch/listen to the television program later, and so forth. On the other hand, when the local time is delayed than the standard time, the recording of the desired content signal is started from the transmission starting time, and therefore, the user can watch the television program by performing an after-recording reproduction, record the television program so as to watch the television program later, and so forth. Thus, the user never fails to watch an early portion of the television program.

A content receiving apparatus detects standard time information included in the content signal transmitted prior to the desired content signal. Furthermore, the transmission starting time is specified based on the standard time included in the detected standard time information, and the local time.

Preferably, a content receiving apparatus is a handheld type. Thereby, it becomes possible for a user to receive and enjoy the content outdoors.

Preferably, a content receiving apparatus is provided with a video monitor for outputting the video content included in the content signal. Thereby, it becomes possible for the user to appreciate the video content included in the content signal.

According to the present invention, it is possible to comfortably appreciate the desired content even when a deviation occurs between the standard time and the local time.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing one embodiment of the present invention;

FIG. 2(A), and FIG. 2(B) are illustrative views showing a timing chart of the FIG. 1 embodiment;

FIG. 3(A), and FIG. 3(B) are illustrative views showing another timing chart of the FIG. 1 embodiment;

FIG. 4 is a flowchart showing one portion of an operation of the FIG. 1 embodiment; and

FIG. 5 is a flowchart showing another portion of the operation of the FIG. 1 embodiment.

### DETAILED DESCRIPTION OF THE PREFERRED EMBODIMENTS

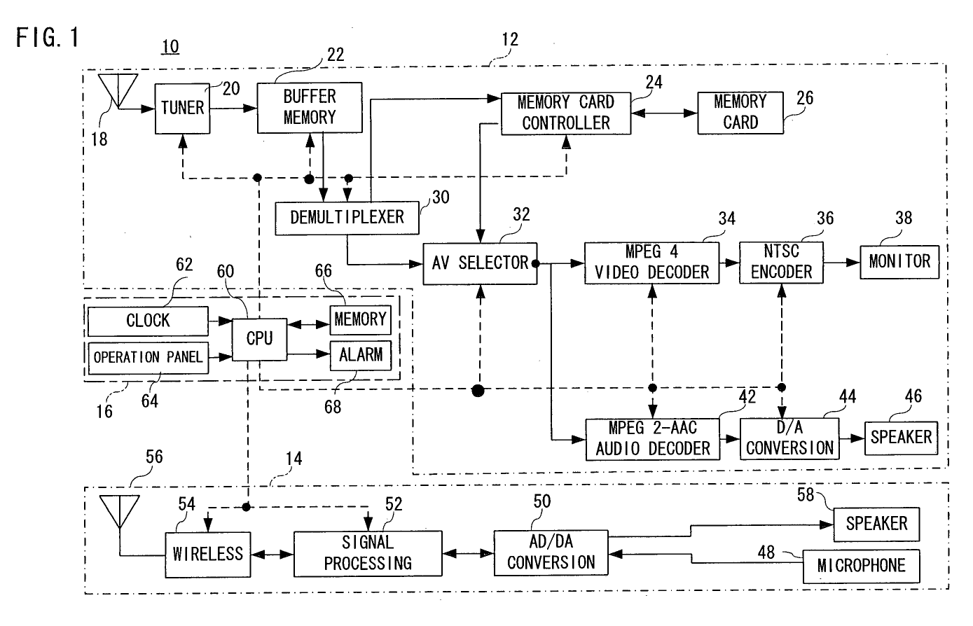

Referring to FIG. 1, a handheld terminal (one-segment receiver) 10 having a digital television broadcast receiving function of this embodiment includes a television broadcast receiving circuit 12 that receives a digital television broadcast so as to perform a watching/listening, a recording, an after-recording reproduction, and etc., a communication circuit 14 for carrying out a communication with a communication partner, and a control circuit 16 for controlling the same.

The television broadcast receiving circuit 12 includes a tuner 20 for receiving a broadcast signal of the digital television broadcast received by an antenna 18, and selecting digital broadcast data (MPEG2-TS, in a case of a terrestrial digital broadcast) of one channel designated by a user out of the received broadcast signals. The digital broadcast data selected by the tuner 20 is applied to a buffer memory 22. The buffer memory 22 accumulates the applied digital broadcast data until a predetermined amount is achieved, and applies the accumulated digital broadcast data to a demultiplexer 30 by each predetermined amount.

The demultiplexer 30 extracts PES data from the applied digital broadcast data, and applies the same to a memory card controller 24. Furthermore, the demultiplexer 30 extracts header information of the digital broadcast data, and applies the same to a CPU 60. The CPU 60 reads a standard time Tdtv from the applied header information.

The memory card controller 24 records the applied PES data into a memory card 26. Thus, a video, and a sound or voices of a desired television program are recorded. It is noted that a semiconductor memory such as a DRAM, a flash memory, and etc., may be used in place of the memory card 26.

Next, a case that the video and the sound or voices of the television program recorded in the memory card 26 are reproduced will be described. The memory card controller 24 reads out the PES data from the memory card 26, and applies the read PES data to an AV selector 32.

The AV selector 32 turns a video PES packet and an audio PES packet into a non-packetization, converts the both into video ES data and audio ES data, respectively, and applies the converted video ES data and the audio ES data to an MPEG4 video decoder 34 and an MPEG2-AAC audio decoder 42, respectively.

The MPEG4 video decoder 34 decodes the applied video ES data so as to generate video data, and applies the generated video data to an NTSC encoder 36. The applied video data is converted into a composite video signal by the NTSC encoder 36, and the converted composite video signal is applied to a monitor 38 such as a liquid crystal display element. As a result, the video of the desired television program is displayed on a screen of the monitor 38.

On the other hand, the MPEG2-AAC audio encoder 42 decodes the applied audio ES data so as to generate audio data. The generated audio data is converted into an analog audio signal by a D/A converter 44, and the converted audio signal is applied to a speaker 46. As a result, the sound or voices of the desired television program is heard from the speaker 46.

It is noted that the handheld terminal 10 of this embodiment is one-segment receiver, and therefore, a compression/encoding of the video is carried out according to an MPEG4 system. However, in a large apparatus such as a television receiver, and etc., the compression/encoding of the video is carried out according to the MPEG2 system. Thus, in the large apparatus, in place of the MPEG4 video decoder 34, an MPEG2 video decoder is used.

Furthermore, in a case of directly watching/listening to the received television broadcast, the digital broadcast data of the desired channel is selected by the tuner 20. The selected digital broadcast data is applied to the demultiplexer 30 via the buffer memory 22.

The demultiplexer 30 extracts the PES data from the applied digital broadcast data, and applies the same to the AV selector 32. The PES data applied to the AV selector 32 is processed similar to the case of reproducing the above-described recorded video and sound or voices, and converted into the composite video signal and the analog audio signal. It is noted that the header information of the digital broadcast data is applied to the CPU 60 by the demultiplexer 30, and the CPU 60 reads the standard time Tdtv from the applied header information.

Next, a description will be given regarding the communication circuit 14. When the sound or voices is input into a microphone 48, the input sound or voices is converted into a sound signal, that is, an analog signal, by the microphone 48. The converted sound signal is amplified by an amplifier (not shown), and the amplified sound signal is converted into sound data, which is a digital signal, by an AD/DA conversion circuit 50. The converted sound data is subjected to an encoding process by a signal processing circuit 52, and furthermore, a modulation process by a wireless circuit 54. Modulated sound data generated by the wireless circuit 54 is transmitted from the antenna 56.

On the other hand, the modulated sound data transmitted from a communication partner is received by the antenna 56, and thereafter, subjected to a demodulation process by the wireless circuit 54, and a decoding process by the signal processing circuit 52. The sound data decoded by the signal processing circuit 52 is converted into the sound signal, which is, the analog signal, by the A/D/DA conversion circuit 50, and the converted sound signal is applied to the speaker 58 via the amplifier (not shown). As a result, the sound or voices transmitted from the communicating partner is heard from the speaker 58.

Next, a description regarding the control circuit 16 will be given. The control circuit 16 includes the CPU 60, and a clock 62, an operation panel 64, a memory 66, and an alarm 68, each of which are connected to the CPU 60.

As shown in FIG. 1, the CPU 60 controls each circuit, that is, the tuner 20, the buffer memory 22, the memory card controller 24, the demultiplexer 30, the AV selector 32, the MPEG4 video encoder 34, the NTSC encoder 36, the MPEG2-AAC audio encoder 42, the DA conversion circuit 44, the signal processing circuit 52, and the wireless circuit 54. In addition, the CPU 60 fetches the standard time Tdtv from the header information of the digital broadcast data as described above.

The clock 62 is a clock circuit contained in the handheld terminal 10, and capable of freely adjusting a time according to an activity pattern of the user. Thus, there are many users who deliberately delay a local time Tel, and act by watching the delayed local time Tel.

The operation panel 64 is a panel used when the user watches/listens to the television program, communicates by the handheld terminal 10, and so forth, and the user applies an instruction from this operation panel 64 to the television broadcast receiving circuit 12 and the communication circuit 14 via the CPU 60.

The memory 66 stores an operating program of the CPU 60, television program information such as a channel of the television program, the television program starting time, a television program ending time, and etc., input by the user, information regarding a deviation between the local time Tel and the standard time Tdtv, and etc. In addition, the alarm 68 informs the user that it is the predetermined time by issuing a sound or a vibration.

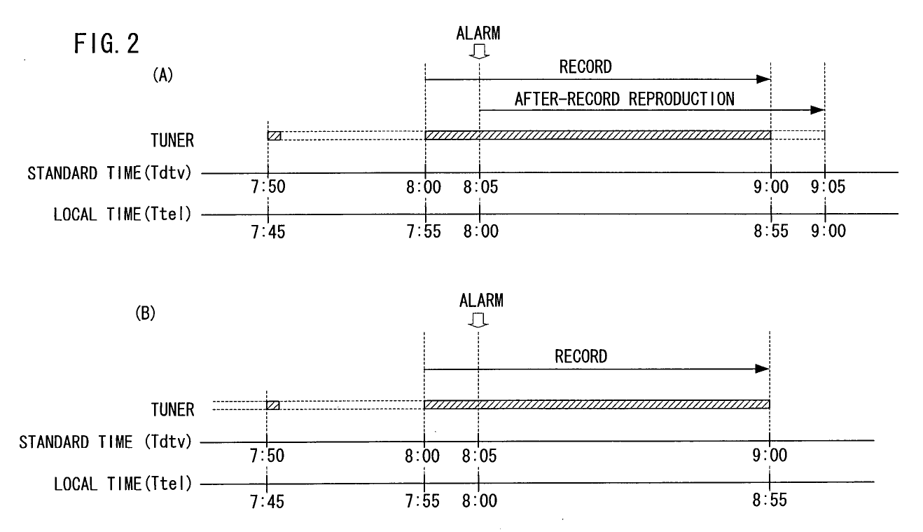

Next, using a timing chart shown in FIG. 2(A) or FIG. 2(B), regarding a case that the local time Tel indicated by the clock 62 is delayed than the standard time Tdtv, an operation of the television broadcast receiving circuit 12 will be described. In this embodiment, on the supposition that the user's desired television program is a television program having a broadcast time period of one hour, which is started at 8 p.m., and ended at 9 p.m. on the standard time Tdtv. In addition, the local time Tel is 5 minutes delayed than the standard time Tdtv.

First, using the timing chart shown in FIG. 2(A), a description will be given regarding a case that the user watches/listens to this television program. The user inputs the channel of the desired television program, the television program starting time, and the television program ending time in advance from the operation panel 64. As a result, when the local time Tel is rendered 7:45 p.m., which is 15 minutes before the television program starting time, a power of the tuner 20 is turned on, and the digital broadcast data of the desired channel is selected. The header information included in the selected digital broadcast data is applied to the CPU 60 via the buffer memory 22.

If the CPU 60 reads the standard time Tdtv from the applied header information, and detects that the local time Tel is 5 minutes delayed than the read standard time Tdtv, the information regarding a deviation between the local time Tel and the standard time Tdtv is caused to be stored in the memory 66. Thereafter, the power of the tuner 20 is turned off. It is noted that in order to confirm the standard time Tdtv, the power of the tuner 20 is turned on 15 minutes before the television program starting time. However, the time at which the power of the tuner 20 is turned on is not limited to 15 minutes before the television program starting time, and it is possible to adjust the starting time between 5 to 30 minutes before the television program starting time depending a situation.

Furthermore, when the local time Tel is rendered 7:55 p.m., taking into consideration the information that the local time Tel stored in the memory 66 is 5 minutes delayed than the standard time Tdtv, it is determined that the standard time Tdtv is rendered 8 p.m., that is, the television program starting time. As a result, the power of the tuner 20 is turned on, and the recording of the desired television program is started.

At this time, the user acts based on the local time Tel, and therefore, the user does not recognize that the television program is started, and recognizes later that local time Tel is rendered 8 p.m., that is, the television program starting time, by the time displayed on the handheld terminal 10 or the alarm 68, and then, starts watching/listening to the television program. By this time, 5 minutes has passed since a start of the broadcast of the television program, and therefore, it is not possible for the user to watch/listen to a content to be failed to watch even if watching the screen of the monitor 38.

This makes the user watch/listen to the television program by a so-called after-recording reproduction, which is to watch/listen to the recorded television program by reproducing the recorded television program from the start while the recording of the television program is continued. Then, when the standard time Tdtv is rendered 9 p.m., which is the television program ending time, it is determined that the broadcast of the television program is ended, and the recording is ended. However, the reproduction is still continued. This allows the user to watch/listen to the program after this. Then, when it is 9 p.m. on the local time Tel, the reproduction of the recorded television program is ended, and the power of the tuner 20 is turned off.

It is noted that there is a case when the user watches/listens to the recorded television program while performing the after-recording reproduction, there is a video such as a CM (commercial message), and etc., intended to move forward during the television program, and the user operates the operation panel 64 so as to move forward that portion. In this case, if it is before the end of the broadcast of the television program when the reproduction is ended, the user changes the screen of the monitor 38 from the reproduced video to the video of the television program currently being broadcast, and as a result, the user can still continue watching/listening to the television program.

Furthermore, using the timing chart in FIG. 2(B), a case that when the user recognizes that it is the television program starting time by the alarm 68, the user cannot watch/listen to the television program because the user is busy will be described. In this case, a process from it is determined that the standard time Tdtv is rendered 8 p.m., that is, the television program starting time, until the power of the tuner 20 is turned on so as to start recording the television program is the same as the process in the case in FIG. 2 (A), and therefore, the description will be omitted.

When the user recognizes that it is 8 p.m. on the local time Tel by the alarm 68, the television program starting time is already passed, and the recording is already started. When it is not possible for the user to watch/listen to the television program by the television program ending time by the after-recording reproduction, the recording to the memory card 26 is continued. In addition, when the standard time Tdtv is rendered 9 p.m., that is, the television program ending time, the recording is ended, and the power of the tuner 20 is turned off. The user can watch/listen to the television program recorded at this time by reproducing the program when the user has the time later.

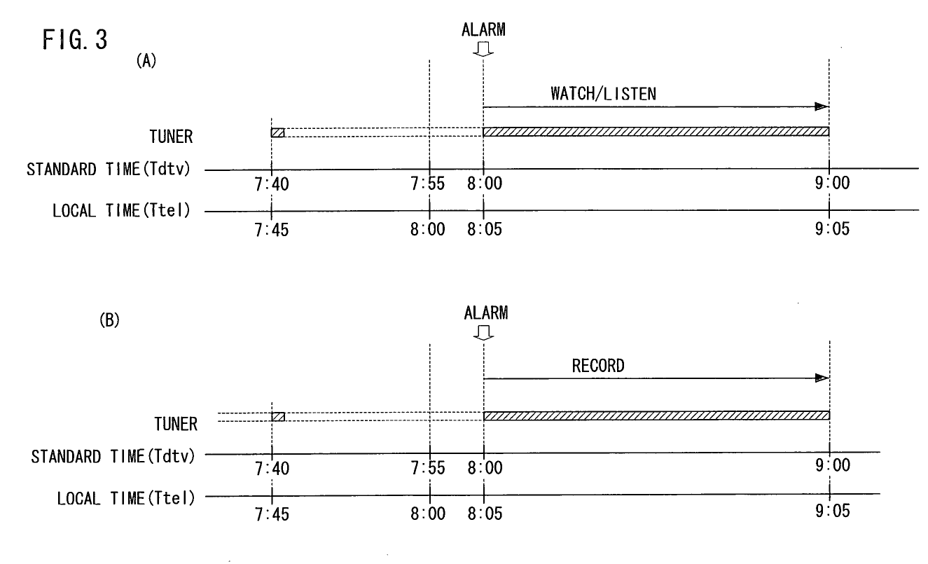

Next, regarding a case that the local time Tel of the clock 62 is faster than the standard time Tdtv, an operation of the television broadcast receiving circuit 12 will be described using a timing chart in FIG. 3(A) or FIG. 3(B). In this embodiment, too, similar to the case in FIG. 2(A) and FIG. 2(B), the user's desired television program is a television program having a broadcast time period of one hour, which is started at 8 p.m., and ended at 9 p.m. on the standard time Tdtv. Furthermore, the local time Tel is a time 5 minutes faster than the standard time Tdtv.

First, using the timing chart in FIG. 3(A), a case that the user watches/listens to this television program will be described. The user inputs the channel, the television program starting time, and the television program ending time of the desired television program in advance from the operation panel 64. As a consequence, when the local time Tel is rendered 7:45 p.m., which is 15 minutes before the television program starting time, the power of the tuner 20 is turned on, and the digital broadcast data of the desired channel is selected. The header information included in the selected digital broadcast data is applied to the CPU 60 via the demultiplexer 30.

The CPU 60 reads the standard time Tdtv from the applied header information, detects that the local time Tel is 5 minutes faster than the read standard time Tdtv, and causes information regarding a deviation between the local time Tel and the standard time Tdtv to be stored in the memory 66. Later, the power of the tuner 20 is turned off. It is noted that in this case, too, the power of the tuner 20 is turned on 15 minutes prior to the television program starting time in order to confirm the standard time Tdtv. However, the time at which the power of the tuner 20 is turned on is not limited to 15 minutes prior to the television program starting time, and it is possible to adjust between 5 to 30 minutes prior to the television program starting time depending on a situation.

Next, when the local time Tel is rendered 8:05 p.m., taking into consideration the information that the local time Tel stored in the memory 66 is faster by 5 minutes than the standard time Tdtv, it is determined that the standard time Tdtv is rendered 8 p.m., which is the television program starting time, and the tuner 20 is turned on. At this time, the user recognizes that it is the television program starting time by the alarm 68, and starts watching/listening to the television program. In this case, the broadcast of the television program has just been started, and therefore, the user can watch/listen to the television program without missing any portion of the television program from a beginning.

Furthermore, when the standard time Tdtv is rendered 9 p.m., which is the television program ending time, it is determined that the television program is ended, and the power of the tuner 20 is turned off.

A case that when the user recognizes that it is the television program starting time by the alarm 68, the user is busy, and therefore, the user cannot watch/listen to the television program will be described using the timing chart in FIG. 3(B). In this case, a process, until which when it is 8 p.m. on the standard time Tdtv, and the user recognizes that it is the television program starting time by the alarm 68, is similar to the case in FIG. 3(A), and therefore, the description will be omitted.

When the user recognizes by the alarm 68 that the standard time Tdtv is rendered 8 p.m., which is the television program starting time, the user operates the operation panel 64 so as to instruct to record the television program. As a result, the recording of the television program is started. In addition, when the standard time Tdtv is rendered 9 p.m., which is the television program ending time, it is determined that the television program is ended, the recording is ended, and the power of the tuner 20 is turned off. The user can watch/listen to the television program recorded at this time by reproducing the program later when the user has the time.

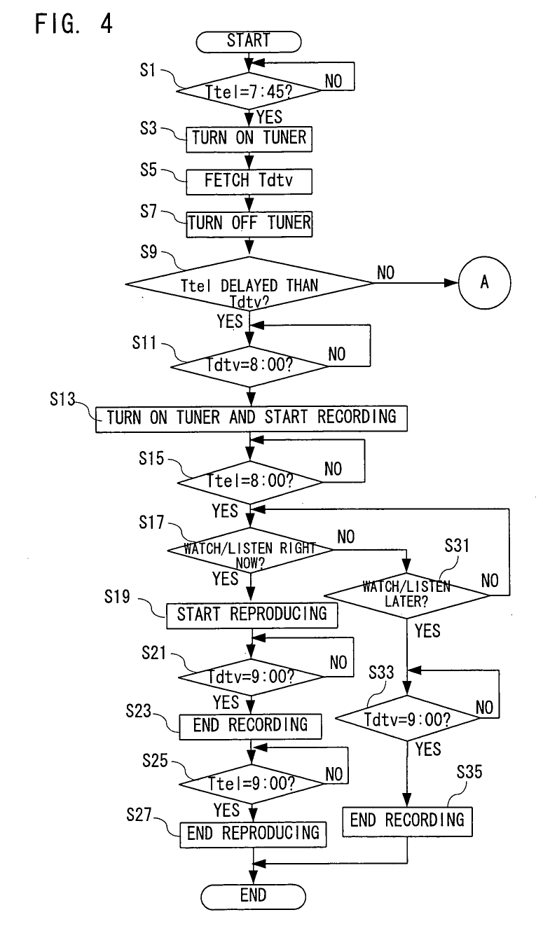

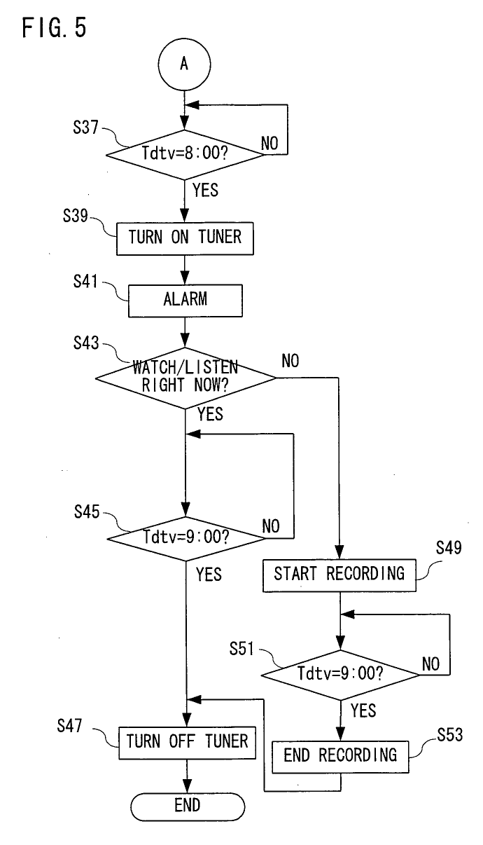

Next, regarding a process of a case of the after-recording reproduction, the recording, and the watching/listening of the television program described using FIG. 2 (A), FIG. 2(B), FIG. 3(A), and FIG. 3(B), a description will be given using flowcharts in FIG. 4 and FIG. 5.

First, referring to FIG. 4, a case that the local time Tel is delayed than the standard time Tdtv will be described. The user inputs in advance from the operation panel 64 the channel, the television program starting time, and the television program ending time of the desired television program. In addition, in a step S1, it is waited until the local time Tel is rendered 7:45 p.m., and when it is 7:45 p.m., the power of the tuner 20 is turned on in a step S3. In a step S5, the header information of the digital broadcast received by the antenna 18 is fetched via the multiplexer 30, and the information regarding a deviation between the standard time Tdtv and the local time Tel is stored into the memory 66. In a step S7, the power of the tuner 20 is turned off.

Next, in a step S9, it is determined whether or not the local time Tel is delayed than the standard time Tdtv. As a result, when it is determined that the local time Tel is delayed than the standard time Tdtv, a process is applied in accordance with the flow described below in order to perform the after-recording reproduction. It is noted that a process of a case that the local time Tel is faster will be described later.

In a step S11, it is waited until the standard time Tdtv is rendered 8 p.m., which is the television program starting time, and when it is 8 p.m., the power of the tuner 20 is turned on, and the recording is started. In a step S15, it is waited until the local time Tel is rendered 8 p.m., and when it is 8 p.m., in a step S17, it is determined whether or not the user promptly watches/listens to the television program already started broadcasting based on the instruction from the user. As a result, in a case that the user watches/listens to the program right now, the after-recording reproduction is performed in a step S19.

Then, in a step S21, the after-recording reproduction is continued until the standard time Tdtv is rendered 9 p.m., which is the television program ending time, and when the standard time Tdtv is rendered 9 p.m., the recording is ended in a step S23.

Furthermore, only the reproduction is continued until the local time Tel is rendered 9 p.m. in a step S25, and when the local time Tel is rendered 9 p.m., the reproduction is ended in a step S27, and the power of the tuner 20 is turned off.

On the other hand, when it is determined that it is not possible to watch/listen to the television program already started broadcasting by the television program ending time by the after-recording reproduction, it is determined whether or not the user watches/listens to the program later based on the instruction from the user in a step S31. As a result, in a case that it is determined that the user watches/listens to the program right now, the process returns to the step S17. On the other hand, when it is determined that the user watches/listens to the program later, the recording is continued until the standard time Tdtv is rendered 9 p.m., which is the television program ending time.

In a step S33, it is determined whether or not the standard time Tdtv is rendered 9 p.m. As a result, when it is determined that the standard time Tdtv is not rendered 9 p.m., the process returns to the step S33. On the other hand, when it is determined that the standard time Tdtv is rendered 9 p.m., the recording is ended in a step S35, and the power of the tuner 20 is turned off.

Next, referring to FIG. 5, a process in a case that the local time Tel is faster than the standard time Tdtv will be described.

When it is determined that the local time Tel is faster than the standard time Tdtv in the step S9 shown in FIG. 4, it is waited until the standard time Tdtv is rendered 8 p.m., which is the television program starting time, in a step S37. In the step S39, the power of the tuner 20 is turned on when the standard time Tdtv is rendered 8 p.m. so as to enable to watch/listen to the television program, and in a step S41, the alarm 68 is operated so as to inform the user that it is rendered the television program starting time.

In a step S43, it is determined whether or not the user promptly watches/listens to the television program based on the instruction from the user. As a result, when it is determined that the user promptly watches/listens to the program, it is rendered possible to continue watching/listening to the television program. In a step S45, it is waited until the standard time Tdtv is rendered 9 p.m., which is the television program ending time, and when it is 9 p.m., the power of the tuner 20 is turned off, and the process is ended in a step S47.

On the other hand, when it is determined that the user does not promptly watch/listen to the television program in the step S43, the power of the tuner 20 is turned on so as to record the television program in a step S49. Then, the recording is continued until the standard time Tdtv is rendered 9 p.m., which is the television program ending time.

When it is determined that the standard time Tdtv is rendered 9 p.m. in a step S51, the recording of the television program is ended in a step S53, and the power of the tuner 20 is turned off in a step S47.

As understood from the above descriptions, the content receiving apparatus such as the handheld terminal 10, which is provided with the clock 62 that the user can adjust to an arbitrary time, and receives a content signal, i.e., a broadcast signal of the desired television broadcast transmitted from a broadcast station using the standard time Tdtv as a reference, fetches the content signal selected in advance by the tuner 20 into the CPU 60 via the buffer memory 22. In addition, the standard time Tdtv is extracted from the header information of the fetched content signal, and the television program starting time registered based on the standard time Tdtv, i.e., a transmission starting time, is specified. As a result, in a case that the local time Tel indicated by the clock 62 is faster than the standard time Tdtv, when it is the transmission starting time, the alarm 68 is operated so as to inform the user of the message. Furthermore, in a case that the local time Tel is delayed than the standard time Tdtv, the power of the tuner 20 is turned on at the transmission starting time, and the recording of the television program is started.

The header information is extracted from the digital broadcast data, which is the content signal transmitted prior to a start of the broadcast of the desired television program. Then, the transmission starting time is specified using the standard time Tdtv included in the header information and the local time Tel indicated by the clock 62. Based on this specified transmission starting time, the user is informed of the message, the recording of the television program is started, and so forth.

The content receiving apparatus is capable of containing the handheld terminal 10 such as a handheld telephone, and etc., and therefore, it is possible to enjoy the content outdoors.

The content receiving apparatus is provided with the monitor 38 displaying a video content, and therefore, it is also possible to appreciate the video content included in the content signal.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A content receiving apparatus provided with a clock circuit keeping a local time, and receiving a desired content signal transmitted using a standard time as a reference, comprising:
a specifier for specifying a transmission starting time of said desired content signal;
an issuer for issuing a message at said transmission starting time when said local time is faster than said standard time; and
a recorder for starting recording said desired content signal from said transmission starting time when said local time is delayed than said standard time.

2. A content receiving apparatus according to claim 1, wherein a received content signal includes standard time information,
said specifier includes a detector for detecting the standard time information from said content signal transmitted prior to said desired content signal, and
a time specifier for specifying said transmission starting time based on a time included in the standard time information detected by said detector, and said local time.

3. A content receiving apparatus according to claim 1 or 2, wherein said content receiving apparatus is a handheld type.

4. A content receiving apparatus according to any one of claims 1 to 3, wherein said desired content signal includes a video content, further comprising:
a video monitor for outputting said video content.

5. A receiving method by a content receiving apparatus provided with a clock circuit keeping a local time, and receiving a desired content signal transmitted using a standard time as a reference, comprising following steps of:
a specifying step for specifying a transmission starting time of said desired content signal;
an issuing step for issuing a message at said transmission starting time when said local time is faster than said standard time; and
a recording step for starting recording said desired content signal from said transmission starting time when said local time is delayed than said standard time.

6. A receiving method of a content receiving apparatus according to claim 5, wherein a received content signal includes standard time information,
said specifying step includes a detecting step for detecting the standard time information from said content signal transmitted prior to the desired content signal, and
a time specifying step for specifying said transmission starting time based on a time included in the standard time information detected by said detecting step, and said local time.
